(19) United States
(12) Patent Application Publication
(10) Pub. No.: US 2012/0191503 A1
(43) Pub. Date: Jul. 26, 2012

(54) INCIDENT COST MODEL

(75) Inventors: Andrew Scott Heiman, Nashville, TN (US); Denise Irene Dahlke, Scottsdale, AZ (US); Robert Henry Ferguson, II, Charlotte, NC (US); Ralph Edward Hester, Mesquite, TX (US); Brian I. Rubin, Matthews, NC (US)

(73) Assignee: BANK OF AMERICA CORPORATION, Charlotte, NC (US)

(21) Appl. No.: 13/012,681

(22) Filed: Jan. 24, 2011

(51) Int. Cl. G06Q 10/00

(52) U.S. Cl. 705/7.28

(57) ABSTRACT

Embodiments of the present invention provide apparatuses and methods for determining the cost of poor quality of an incident within a business. One way to measure costs associated with an incident is by measuring failed customer interactions (“FCIs”). FCIs are defined as incidents that occur within the business that either directly or indirectly affect a customer's ability to use a product or service offered by the business. In most situations an FCI relates to a failed interaction between the business and the customer through a channel that affected the customer's use of a product or service through the channel. The cost of poor quality application calculates the total cost of an incident through a multifaceted valuation that factors in hard metrics, such as but not limited to actual costs, duration, channel costs, FCI severity, etc. in order to calculate a remediation cost, a channel FCI cost, and a reputation cost.

### FIELD

This invention relates generally to calculating the total cost of an incident that occurs within a business, and more particularly, embodiments of the invention relate to apparatuses and methods for calculating the remediation costs, failed customer interaction (“FCI”) channel costs, and reputational costs associated with incidents occurring within a business.

### BACKGROUND

When a business experiences an incident, the incident often affects the day to day operations of the business and results in potential monetary losses for the business. An incident can include, but is not limited to, system bugs, partial system failures, complete system outages, etc. on one or more systems, which prevents customers from using the goods or services (“products”) provided by the business. Incidents within a business can result in failed customer interactions (“FCIs”) because for every incident one or more customers may be affected by the business's failure to provide at least a part of a product to the one or more customers. The tangible losses a business experiences with respect to the incident are generally related to investigating the incident, determining a fix for the incident, and implementing the fix for the incident. The process of investigating an incident, determining a fix, and implementing the fix is often monitored within each business in order to allow the business to track the incident and how the business remediated the incident. However, the costs associated with investigating an incident, determining a fix, and implementing the fix are often not tracked or tracked accurately within businesses. Therefore, businesses may not have a good idea of the total costs that can be associated with an incident. For example, costs associated with incidents are not only due to investigating and fixing the incident, but there are often unrelated costs that are hard to track, measure, and quantify.

There are complicated issues in determining how an incident affects a business and measuring the total costs to the business when an incident occurs. Therefore, there is a need for apparatuses and methods for effectively determining how an incident affects a business and measuring the total costs of the incident throughout the business.

### BRIEF SUMMARY

Embodiments of the present invention address the above needs and/or achieve other advantages by providing apparatuses (e.g., a system, computer program product, and/or other device) and methods for determining how an incident can affect a business and how the business can calculate the total costs associated with the incident.

Embodiments of the present invention provide apparatuses and methods for determining the cost of poor quality of an incident within a business. One way to measure costs associated with an incident is by measuring failed customer interactions (“FCIs”). FCIs are defined as incidents that occur within the business that either directly or indirectly affect a customer's ability to use a product or service offered by the business. In most situations an FCI relates to a failed interaction between the business and the customer through a channel that affected the customer's use of a product or service through the channel. The cost of poor quality application calculates the total cost of an incident through a multifaceted valuation that factors in hard metrics, such as but not limited to actual costs, duration, channel costs, FCI severity, etc. in order to calculate a remediation cost, a channel FCI cost, and a reputation cost.

Embodiments of the invention comprise a method, system and computer program product for determining a negative impression cost of an incident, determining a direct loss of revenue cost of an incident, determining an increased cost to serve of the incident, and determining a channel failed customer interaction cost based in part on the negative impression cost, the direct loss of revenue cost, and the increased cost to serve, through the use of the processing device.

In further accord with an embodiment of the invention, determining the negative impression cost comprises determining an attrition cost. In another embodiment of the invention, determining the attrition cost comprises correlating failed customer interactions with a failed customer interaction value based on the severity of the failed customer interactions or the problem incident ratio; determining the change in an attrition rate before and after the incident; determining a profitability of a customer; and calculating the attrition cost based at least in part on the failed customer interaction value, the change in the attrition rate, and the profitability of the customer.

In yet another embodiment of the invention, determining the negative impression cost comprises determining a less likely to deepen cost. In still another embodiment of the invention, determining the less likely to deepen cost comprises correlating failed customer interactions with a failed customer interaction value based on the severity of the failed customer interactions or the problem incident ratio; determining the change in a likely to add a new product rate before and after the incident; determining a profitability of a product; and calculating the less likely to deepen cost at least in part on the failed customer interaction value, the change in the less likely to deepen rate, and the profitability of the product.

In further accord with an embodiment of the invention, determining the negative impression cost comprises determining a reputation cost. In another embodiment of the invention determining the reputation cost comprises determining a number of people that receive a secondary negative impression from the incident; determining a secondary attrition cost for the number of people that receive the secondary negative impression; determining a secondary least likely to deepen cost for the number of people that receive the secondary negative impression; and calculating the reputation cost based at least in part on the secondary attrition cost or the secondary least likely to deepen cost.

In still another embodiment of the invention, determining the direct loss of revenue cost comprises determining a lost advertising cost; determining a lost product revenue cost; determining a lost fee revenue cost; and calculating the direct loss of revenue cost based at least in part on the lost advertising cost, the lost product revenue cost, or the lost fee revenue.

In yet another embodiment of the invention, determining the increased cost to serve comprises determining an available channel that can be used outside of an incident channel that is affected by the incident; determining a number of failed customer interactions related to the incident; determining a percentage of customers expected to use the available channel; determining a difference in the cost to serve of the available channel and the incident channel; and calculating the increased cost to serve based at least in part on the number of failed customer interactions, the percentage of customers expected to use the available channel, and the difference in the cost to serve of the available channel and the incident channel.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 provides a high level flow diagram outlining the process for determining the cost of poor quality for an incident, in accordance with one embodiment of the invention;

FIG. 2 provides a cost of poor quality system environment, in accordance with one embodiment of the invention;

FIG. 3 provides a high level flow diagram outlining the process for determining the remediation costs, in accordance with one embodiment of the invention;

FIG. 4 provides a high level flow diagram outlining the process for determining the channel FCI costs, in accordance with one embodiment of the invention;

FIG. 5 provides a process flow diagram outlining the process for determining the attrition rate for the channel FCI cost, in accordance with one embodiment of the invention;

FIG. 6 provides a process flow diagram outlining the process for determining the less likely to deepen channel FCI cost, in accordance with one embodiment of the invention;

FIG. 7 provides a process flow diagram outlining the process for determining the increased cost to serve for the channel FCI cost, in accordance with one embodiment of the invention;

FIG. 8 provides a process flow diagram outlining the process for determining the direct loss of revenue cost for the channel FCI cost, in accordance with one embodiment of the invention;

FIG. 9 provides a process flow diagram outlining the process for determining the reputation cost for the channel FCI cost, in accordance with one embodiment the invention;

FIG. 10 provides a process flow diagram outlining the process for determining the reputational costs, in accordance with one embodiment of the invention;

FIG. 11 provides a cost of poor quality interface illustrating the input page for the remediation costs and channel FCI costs, in accordance with one embodiment of the invention;

FIG. 12 provides an interface illustrating the output interface for the attrition costs, in accordance with one embodiment of the invention;

FIG. 13 provides an interface illustrating the output interface for the less likely to deepen cost, in accordance with one embodiment of the invention;

FIG. 14 provides an interface illustrating the output interface for the increased cost to serve, in accordance with one embodiment of the invention;

FIG. 15 provides an interface illustrating the output interface for the loss of direct revenue cost, in accordance with one embodiment of the invention;

FIG. 16 provides an interface illustrating the output interface for the reputation cost, in accordance with one embodiment of the invention;

FIG. 17 provides an interface illustrating output interfaces for the reputational costs and the total incident cost of poor quality, in accordance with one embodiment of the invention;

FIG. 18 provides an interface illustrating the estimation of the restoral value cost, in accordance with one embodiment of the invention; and

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As explained in further detail throughout this application, one way to measure costs associated with an incident in a business is by measuring failed customer interactions (“FCIs”) associated with the incident. FCIs are defined as incidents that occur within the business that either directly or indirectly affect a customer's ability to use a product or service offered by the business. In most situations an FCI deals with some type of interaction between the business and the customer through a channel (i.e. telephone call, website, point of sale (“POS”) machine, face-to-face transaction, etc.) in which the customer had an experience that affected the customer's use of a product or service through the channel. When a business experiences an incident resulting in a large number of FCIs it is unclear as to what is the actual cost to the business. The cost of poor quality application is a framework for an incident based approach that calculates the total cost of an incident through a multifaceted valuation application that factors in hard metrics, such as but not limited to actual costs, duration, channel costs, and FCI severity to assess the costs associated with the incident.

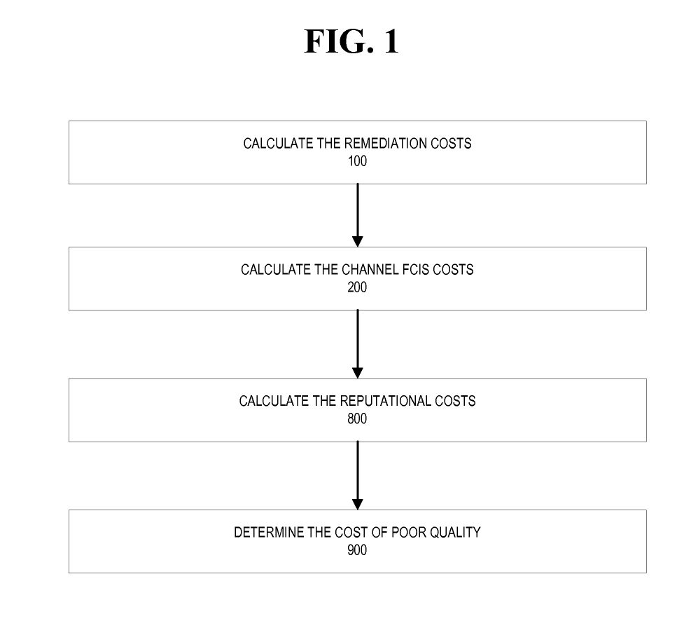

FIG. 1 illustrates one embodiment of a high level flow diagram outlining the process for determining the cost of poor quality for an incident within a business. As illustrated in block 100 of FIG. 1, in order to calculate the cost of poor quality is to calculate the remediation costs may be determined. As explained in further detail later, the remediation costs of an incident may typically comprise of the cost of restoral (i.e. the resources and time that employees at the business use to investigate, determine the cause, and fix the incident), the executive costs (i.e. high level employee time at the business), capital rework costs (i.e. costs associated with investing in new hardware/software to fix the incident), and communication costs (i.e. costs associated with the communication between the employees charged with fixing the incident, travel, telecommunication, etc.).

Also, the cost of poor quality may include the channel FCI costs, as illustrated in block 200 of FIG. 1. As explained in further detail later, the channel FCI costs may typically comprise an attrition cost (i.e. costs of losing a customer), a less likely to deepen relationship cost (i.e. costs associated with losing additional business from a customer), an increased cost to serve (i.e. costs of serving customers though another channel), a lost of direct revenue cost (i.e. cost of lost purchases, lost fees, lost interest, etc.), and a reputation cost (i.e. word of mouth spread of negative news).

As illustrated in block 300 of FIG. 1, calculating the cost of poor quality may include the reputational costs of the incident. As explained in further detail later, the reputational costs of the incident are based on the media coverage of the incident through both traditional and social media outlets. As illustrated in block 900 of FIG. 1, the remediation costs, channel FCI costs, and reputational costs are combined to determine the total cost of poor quality of the incident.

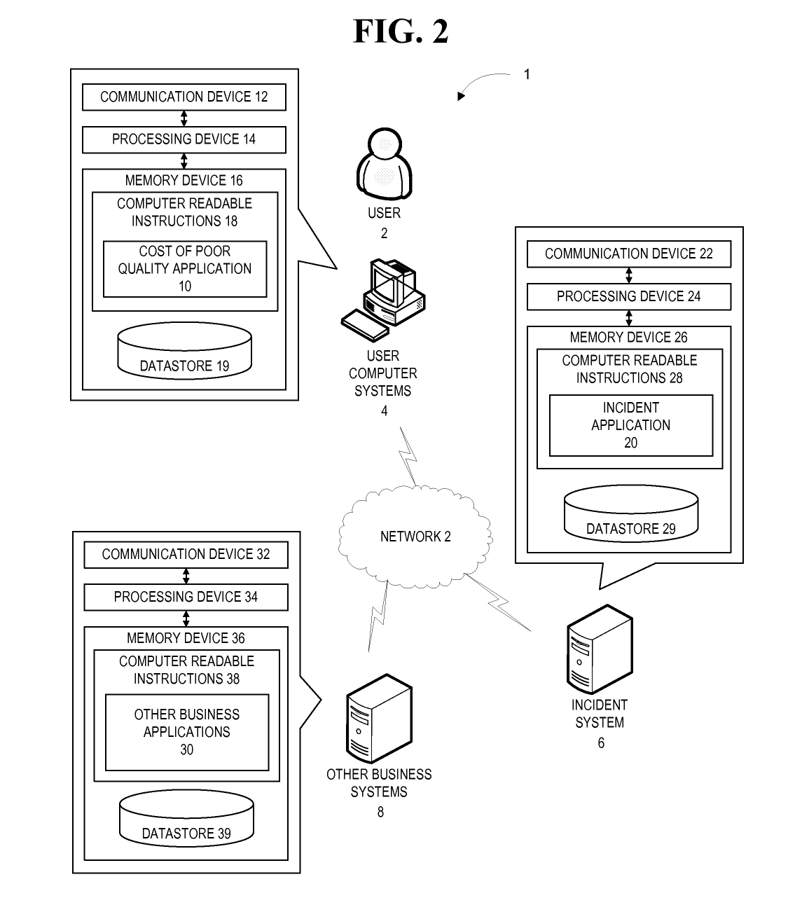

FIG. 2 illustrates a cost of poor quality system 1, in accordance with an embodiment of the present invention. As illustrated in FIG. 1, the user computer systems 4 are operatively coupled, via a network 2 to the incident system 6, and other business systems 8. In this way, the user 3 can receive and send information from and to the incident system 6 and other business systems 8. The user 3, in some embodiments of the invention, is an employee of the business who is tasked with determining the total cost of an incident that has occurred within the business. In other embodiments of the invention the user 3 is an agent, contractor, independent contractor, executive, or other person designated to act on behalf of the business. In other embodiments of the invention, the user 3 is not necessary to determine the total cost of an incident that has occurred with in the business, in that the cost of an incident can be determined through the use of computer systems and applications automatically. The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 2, the user computer system 4 generally comprises a communication device 12, a processing device 14, and a memory device 16. In some embodiments of the invention the user computer system 4 can be a stand alone system or part of another system that is also operatively connected through the network 2. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12, and the memory device 16. The processing device 14 uses the communication device 12 to communicate with the network 2, and other devices on the network 2, such as, but not limited to, the incident system 6 and other business systems 8. Furthermore, the user computer systems 4 can be located at various sites throughout the business and can communicate with each other, as well as other systems and devices over the network 2. As such, the communication device 12 generally comprises a modem, server, or other device for communicating with other devices on the network 2, and a display, camera, keypad, mouse, keyboard, microphone, and/or speakers for communicating with one or more users 3.

As further illustrated in FIG. 2, the user computer system 4 comprises computer-readable instructions 18 stored in the memory device 16, which in one embodiment include the computer-readable instructions 18 of a cost of poor quality application 10. In some embodiments, the memory device 16 includes a datastore 19 for storing data related to the user computer systems 4, including but not limited to data created and/or used by the cost of poor quality application 10. The cost of poor quality application 10 allows the user 3 to receive information about incidents from the incident system 6, as well as other business information from the other business systems 8, and use the information to calculate a cost of poor quality for one or more incidents. In other embodiments of the invention, the cost of poor quality application may be located on the incident system 6, other business systems 8, or other system within the business or outside of the business.

As further illustrated in FIG. 2, the incident system 6 generally comprises a communication device 22, a processing device 24, and a memory device 26. The processing device 24 is operatively coupled to the communication device 22 and the memory device 26. The processing device 24 uses the communication device 22 to communicate with the network 2, and other devices on the network 2 such as, but not limited to, the user computer systems 4 and the other business systems 8. As such, the communication device 22 generally comprises a modem, server, or other device(s) for communicating with other devices on the network 2.

As illustrated in FIG. 2, the incident system 6 comprises computer-readable program instructions 28 stored in the memory device 26, which in one embodiment includes the computer-readable instructions 28 of an incident application 20. In some embodiments, the memory device 26 includes a datastore 29 for storing data related to the incident system 6, including but not limited to data created and/or used by the incident application 20. The incident application 20 captures, stores, and reports information related to any incidents that occur within the business.

As further illustrated in FIG. 2, the other business systems 8 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the user computer systems 4 and the incident system 6. As such, the communication device 32 generally comprises a modem, server, or other device(s) for communicating with other devices on the network 2.

As illustrated in FIG. 2, the other business systems 8 comprise computer-readable program instructions 38 stored in the memory device 36, which in one embodiment includes the computer-readable instructions 38 of other business applications 30. In some embodiments, the memory device 36 includes a datastore 39 for storing data related to the other business systems 8, including but not limited to data created and/or used by the other business applications 30. The other business applications 30 capture, store, and send information to users 3, other employees, and business systems for use in different types of applications, etc. throughout the business.

It will be understood that systems, devices, servers, processors, computers, networks, and other devices described herein may be made up of one system, device, server, processor, computer, network, etc., or numerous systems, devices, servers, processors, computers, networks, etc. working in conjunction with each other. Also, it is to be understood that use of the term computer system includes, but is not limited, desktop, laptop, smart phone, personal display device (PDA), televisions with network access, or any other electronic system that has a communication device, processing device, and memory device.

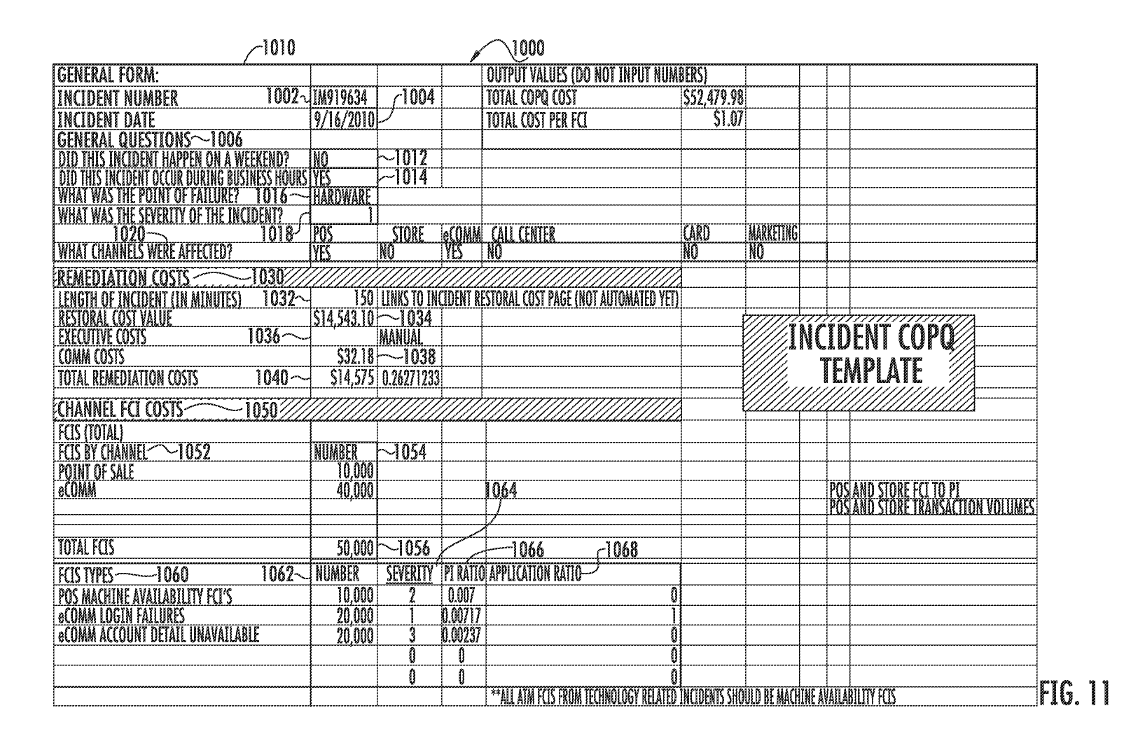

FIGS. 11 through 17 illustrate interfaces for input and output sections for the cost of poor quality application 10. In the example illustrated throughout FIGS. 11 to 17 the business is a retail business that has point of sale (“POS”) machines, physical stores, call centers, internet e-commerce websites, issues credit cards, etc. In this particular example the incident being tracked is a failure in the retail business that affected customers' ability to use POS machines and the e-commerce website that customers can use to purchase products.

In other embodiments of the invention, the business could be a bank or other financial institution that has a failure in the bank that affects the customers' ability to use the bank's automated transaction machines (“ATMs”) or e-commerce website through which customers can log into their accounts at the bank. However, it is to be understood that the framework for determining the cost of poor quality described herein, as well as the cost of poor quality application 10 illustrated throughout, can be used with any type of business. Furthermore in any embodiments that are generally described as involving a “bank,” one of ordinary skill in the art will appreciate that other embodiments of the invention may involve other financial institutions, or businesses outside of financial institutions that take the place of or work in connection with a bank.

In order to use the cost of poor quality application 10 illustrated and described throughout this application the user 3 may first enter some general information into the cost of poor quality application 10. FIG. 11 illustrates one section of the cost of poor quality interface 1000. FIG. 11 comprises a general input section 1010, in which the user can fill out general information related to an incident that has occurred within the business. In some embodiments, this information may be filled out automatically, for example, through information received from the incident application 20 about each incident that occurs within the business. The information the user 3 may enter or that is automatically populated may include, but is not limited to, the incident number 1002, the incident date 1004, and the general questions 1006. The general questions section 1006 may include a weekend incident question 1012, a business hour incident question 1014, a point of failure incident question 1016, and a severity question 1018. The weekend incident question 1012 relates to whether or not the incident occurred on a weekend. The business hour incident question 1014 relates to if the incident occurred during normal business hours. The point of failure question 1014 describes where the failure originated, for example, in one embodiment the user 3 can select from different points of failure, including but not limited to application, facilities, hardware, network, procedural error, service provider, software provider, etc. The level of severity question 1018 lets the user 3 rate the severity of the incident on a scale of 1 to 4, with 1 being the most severe and 4 being least severe. In other embodiments the severity can be rated using other scales or metrics. The last question in the general input section 1010 is the affected channels question 1020. This question allows the user 3 to indicate which channels at the business that are used by customers were affected by the incident. The channels illustrated in this example for a retail business includes POS machine, store location systems, e-commerce websites, call centers, card services, and marketing systems, In this example the user 3 can select what channels are affected by the incident by indicating yes or no in the drop-down menu. In other embodiments the affected channels can be chosen in another way. The responses to the general questions can either be used for general bookkeeping reasons or may be used by the cost of poor quality application 10 to calculate the cost of poor quality, as explained in further detail later. In other embodiments of the invention, the user 3 may need to answer additional questions in order to allow the cost of poor quality application 10 to calculate additional costs associated with an incident or provide more accurate costs associated with an incident.

In other embodiments of the invention for other types of business, such as a bank, the channels that could be affected include, but are not limited to, ATMs, banking centers, e-commerce website, call center, card services, Global Wealth & Investment Management (“GWIM”), Home Loans and Insurance Technology (“HLIT”), etc.

After the user 3 fills out the general information, the user 3 can input other information related to the incident in the cost of poor quality application 10. Again, in some embodiments of the invention, and elsewhere throughout this application, the information in the cost of poor quality application 10 can be filled out automatically so the user 3 does not need to manually fill out the information.

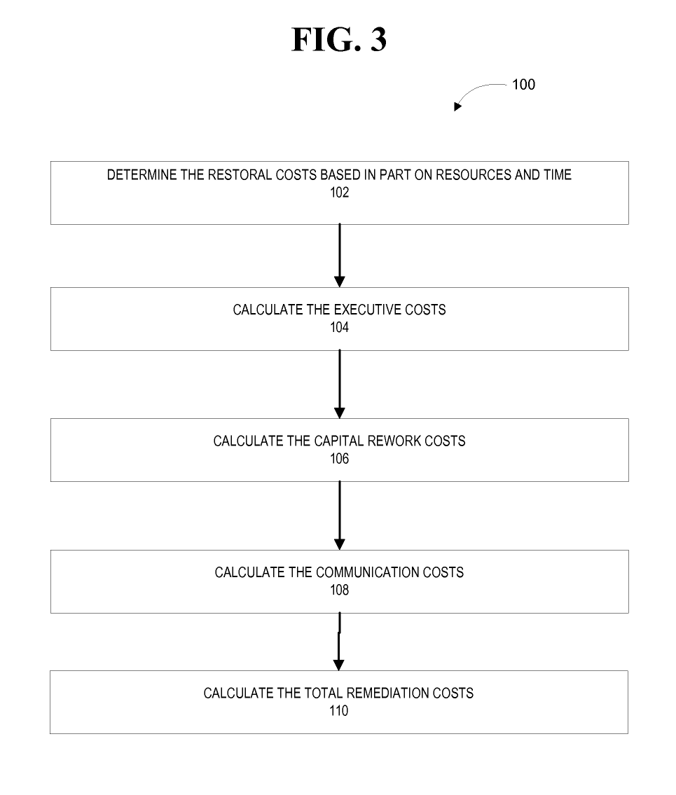

FIG. 3 illustrates a flow diagram outlining the process for determining the remediation costs and FIG. 11 illustrates one embodiment of the remediation costs interface 1030. As illustrated in block 102 of FIG. 3, the user may determine the restoral costs based in part on the resources and time used to restore the systems affected during the incident. As illustrated in FIG. 11 the user 3 can enter the length of the incident in the incident length section 1032. In this example the incident lasted 150 minutes. The restoral cost value 1034 can be calculated by taking historical data of restoral costs in the past on a per minute, hour, etc. time frame and multiplying it by the length of the incident in the incident length section 1032.

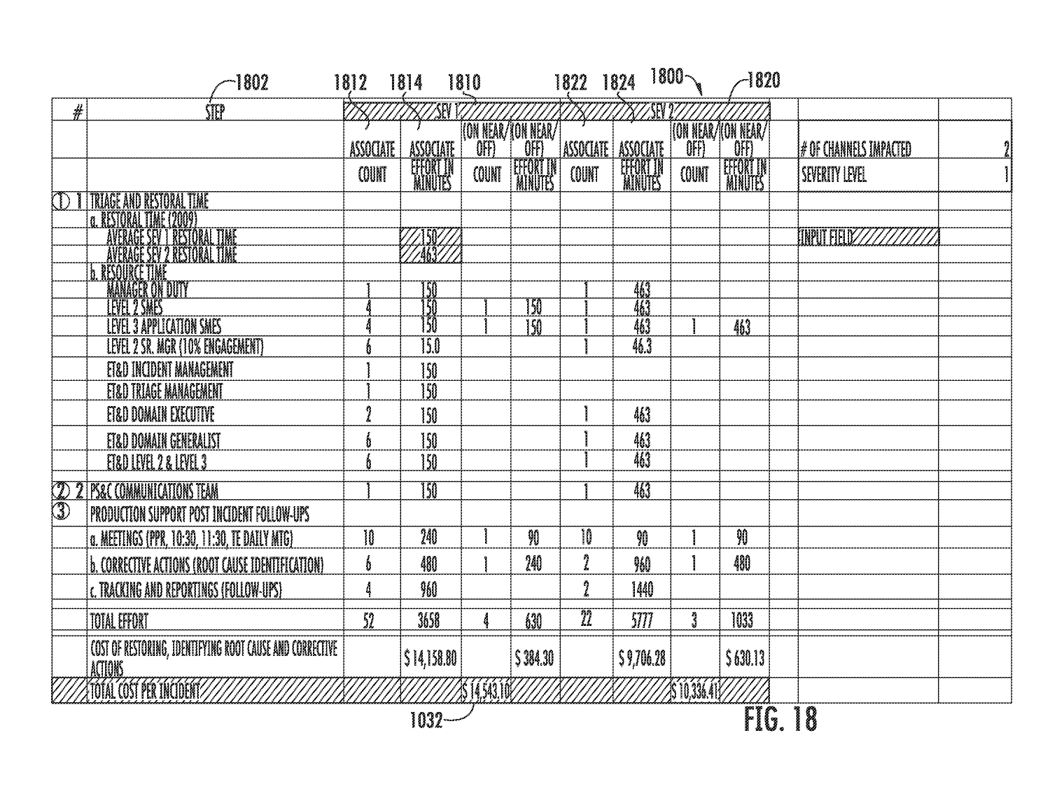

In other embodiments of the invention, the restoral cost value 1034 can be calculated by estimating the amount of associate resource time spent on average on an incident from each of the associates at the business, such as the manager on duty, the Subject Matter Expert (“SME”), senior managers, incident management, domain executive, domain generalist, as well as other associates and associate time spent in the support and follow-up meetings for the incident. The total time spent by the associates of the business can be multiplied by an average cost per associate time in order to determine the total restoral value cost 1034 per incident. One example of the estimation of the restoral value cost 1034 is illustrated in FIG. 18. FIG. 18 illustrates a restoral interface 1800, which breaks the restoral value cost 1043 down into the restoral steps 1802, severity 1 restoral costs 1810, and severity 2 restoral costs 1820. The severity 1 and severity 2 restoral costs 1810, 1820 are broken down further into number of associates 1812 1822, which indicates the number of associates working on the restoral, and associate effort 1814 1824, which indicates the amount of time spent by each associate.

The remediation costs, as illustrated by block 104 in FIG. 3, may also include executive costs 1036. In one embodiment of the invention, the executive costs 1036 are calculated by determining the historical average cost per minute, hour, etc. of an executive's time and multiplying time spent by executives on the incident by the average executive's historical cost per time. In the example illustrated in FIG. 11, the executive costs 1036 were zero because this incident was not significant enough to be brought to the attention of the executives.

The remediation costs, as illustrated in block 106 of FIG. 3, may also be calculated with capital rework costs. The capital rework costs are not illustrated in FIG. 11 because they do not exist for the example shown in FIGS. 11 through 17. However, if there is an associated cost of purchasing new hardware, downloading new software, installing some additional steps in a process, paying for consulting work to program the hardware or software, etc. the additional costs may be captured and listed as capital rework costs in the remediation cost interface 1030.

As illustrated in block 108 of FIG. 3, remediation costs may also include the calculation of communication costs 1038. The communication costs 1038 of the incident can be determined based on the length of the incident. An average cost for communication can be based on historical averages of the time spent by associates on teleconference meetings discussing the incident, determining a fix, and implementing the fix. In some embodiments the telecommunication cost may be insignificant to the overall cost of an incident, so it could be removed from the calculation. In other embodiments of the invention the communication costs could include not only telecommunication costs, but also travel costs of employees and executives related to fixing the incident.

As illustrated in block 110, the cost of poor quality application 10 sums all of the costs in the remediation cost interface 1030 to determine the total remediation costs 1040. The total remediation costs 1040 are illustrated in the remediation cost interface 1030, as illustrated in FIG. 11.

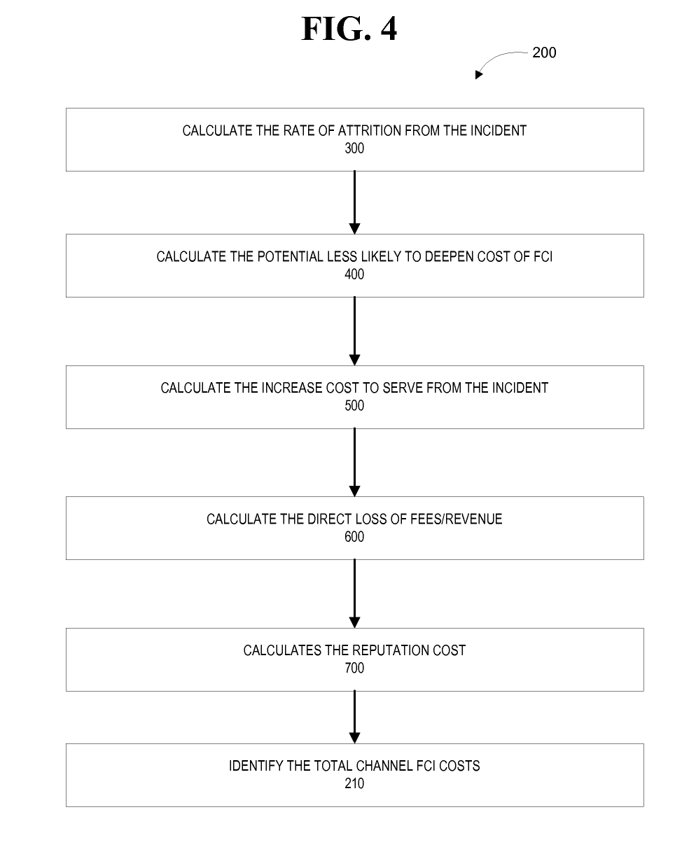

As illustrated in block 200 of FIG. 1, the channel FCI costs may be calculated in order to determine the total cost of poor quality. FIG. 4 illustrates a high level process flow for determining the channel FCI costs. Each step in the process is described in more detail below, but is generally described here. The channel FCI costs may be calculated in part by determining the rate of attrition from the incident, as illustrated by block 300. As illustrated by block 400 the calculating the channel FCI costs may include calculating the potential less likely to deepen cost of the FCI. The less likely to deepen cost is the cost associated with a customer who experiences the incident and decides not to purchase or use another product with the business because of the customer's negative experience with the incident. As illustrated by block 500, the increased cost to serve the customers from the incident may be included in the channel FCI costs because the customers may have to use another channel offered by the business while the incident is taking place and being fixed. The channel FCI costs may also include a step of calculating the direct loss of revenue or fees from the incident, as illustrated in block 600 of FIG. 4. As illustrated by block 700 of FIG. 4, the channel FCI costs may also take into account the reputation cost associated with the negative impression of customers. Finally, as illustrated in block 210, the total channel FCI cost of the incident is calculated by combining the costs identified from blocks 300 through 700.

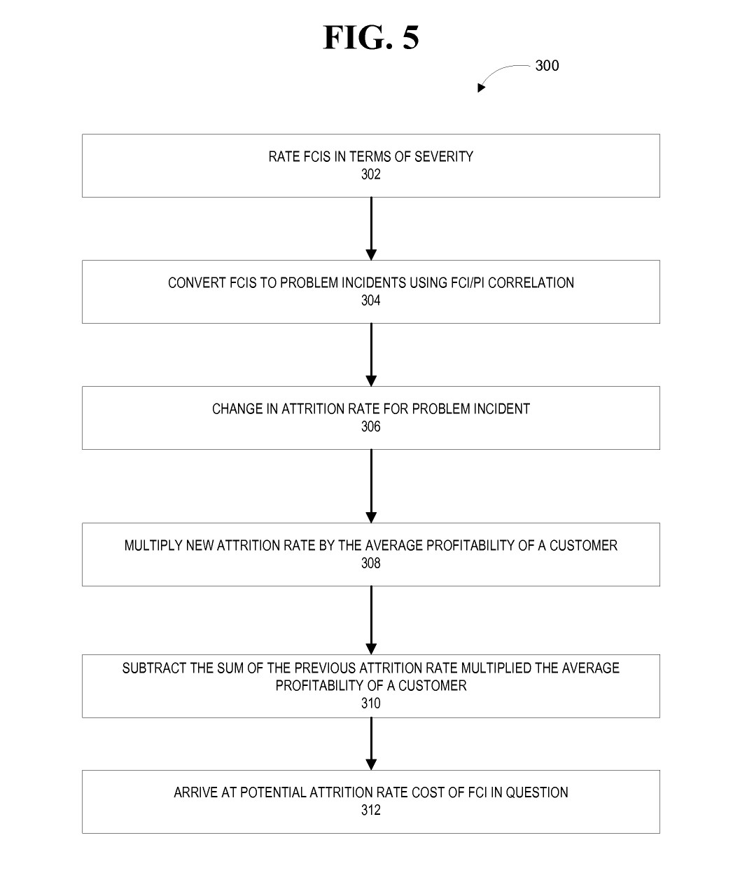

FIG. 5 illustrates a process flow for determining the channel FCI cost that is attributable to the rate of attrition for the incident. As illustrated by block 302 in FIG. 5, the determining the attrition rate may be done by rating the FCIs of the incident in terms of severity. In some embodiments of the invention, the user 3 can rate the FCIs automatically through the cost of poor quality application 10. As illustrated in FIG. 11, in the channel FCI by Channel section 1052 within the FCI costs section 1050, the user 3 can select the types of FCIs associated with the incident. For example, in the case of a retail business, the user 3 can select between the POS machine, store, e-commerce, call center, card, etc. channels and enter in how many FCIs were associated with each channel for the incident. In some embodiments of the invention, the cost of poor quality application 10 can link directly the with the incident application 20 on the incident system 6 in order to automatically receive the type and number of FCIs associated with each incident.

As illustrated in the FCI Types section 1060, the user 3 can select the type of FCIs for each channel selected in the FCIs by Channel section 1052. The FCI types include the types of failures that the customer experienced because of the incident. For example, in the case of a retail business, the FCIs failures could be related to account logins, purchase payment, reward enrollments, card account detail views, product image, home page failures, product offer failures, POS availability, malfunctions on the POS, POS connectivity issues, store inventory system failures, ordering failures, shipping failures, etc.

In other embodiments of the invention, when the business is a bank the FCI types may include e-commerce failures related to account logins, fund transfers, bill payment, enrollment, card details, account details, e-bill delivery, image errors, e-statement failures, account opening errors, home page failures, product offers failures, small business account failures, payroll movement errors, mortgager origination failures, mortgage fulfillment errors, mortgage account details errors, insurance access failures, or other e-commerce issues. The ATM failures could be related to machine availability issues, frozen transactions, captured cards, cash rejects, check rejects, image deposit errors, image deposit holds, deposit claims, dispense claims, etc. Banking center teller failures could be related to teller equipment or platform issues. The call center failures could be related to systems that do not work, resource tools that the call center associate cannot use, dropped calls, etc. The severity for each of the FCIs listed in the FCI Types section 1060 can be automatically populated in some embodiments for standardization, or can be assigned by a user 3 for flexibility in rating the severity of the FCIs related to the incident.

In some embodiments of the invention, every possible FCI at the business is rated based on severity level by one or more groups at the business. Therefore, when the FCI is selected for an incident the FCI severity rating is automatically populated by the cost of poor quality application 10. One way to calculate FCI severity is to measure how the business views how customers are affected when each particular FCI occurs. In some embodiments, the severity is ranked as 1, 2, and 3, with one being most severe and 3 being the least severe. In other embodiments of the invention, the severity can be ranked on other scales or using other data collected from customer feedback. In still other embodiments of the invention, the user 3 or the groups within the business can rank the severity of each of the FCIs affected by the incident using the cost of poor quality application 10 as the FCIs are selected.

As illustrated by block 304 in FIG. 5, once the severity of the FCIs are rated the user 3 can convert the FCIs to problem incident (“PI”) ratios. PI ratios are a measure of the how the customers actually feel about the FCIs that occur when there are incidents in the business. In order to determine the PI ratios the business can evaluate customer feedback information. For example, the business can identify customer feedback information through surveys, e-mails to the help centers within the business, social media information that is data mined, etc. about how customers feel about the business and/or incidents that occur within the business. The business can run statistical regression analysis models against the customer feedback information as it relates to each of the FCIs. For example, if an incident affects a POS machine, customers cannot make transactions using the POS machine. The business knows on average the number of customers that are affected during an incident based on the normal or average usage rates of POS machines for the time of day and duration of the incident. The business also can determine the average number of customers who have a negative impression of this type of FCI from the customer feedback information gathered from surveys, complaints, social media, etc. From a regression analysis the business can calculate for each FCI a PI ratio of the predicted number of customers who realize that the FCI occurred, are remembering the FCI, have a negative impression of the FCI, and will take a negative action as a response to the FCI.

While the severity level is a measure of how the business feels that a FCI affects a customer, alternatively, the PI ratio is a measure or prediction of how the actual customers feel on average that a FCI affects them. In other embodiments, other types of data analysis or customer feedback information can be used to determine metrics associated with how customers feel that FCIs affect them. The business may feel that an FCI affects a customer one way, but the customer might not actually realize that there was an FCI. However, in other cases the customer may feel that an FCI impacts them more than the business may feel that the FCI impacts the customer. The FCI severity level and PI ratio can be used alone or in combination throughout the cost of poor quality application 10 in order to determine various costs associated with the FCIs that occur as a result of an incident. Thus, the PI ratio provides a way to statistically discover which FCI types are more impactful to customers of the business.

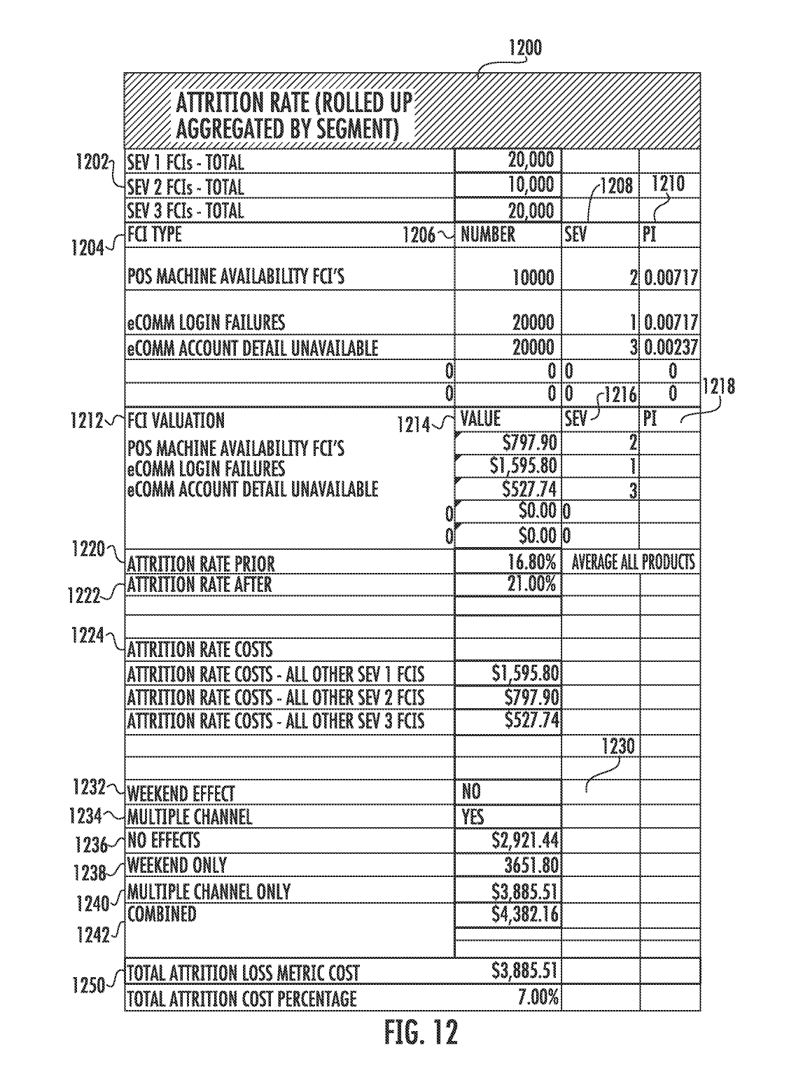

As illustrated by block 306 the change in attrition rate for the problem incidents may be determined. FIG. 12 illustrates the attrition rate output interface 1200, which illustrates the results of the attrition cost analysis based on the input entered into the general questions section 1010 and the channel FCI cost section 1050. The attrition rate output interface 1200 illustrates a summary of the severity FCIs 1202, which lists the number of FCIs for each severity level. Furthermore, the FCI type section 1204, list the FCI number 1206, severity 1208, and PI ratio 1210, as they were entered or populated in the channel FCI costs section 1050. The cost of poor quality application 10 calculates the cost for each FCI in the FCI valuation section 1212. The attrition rate prior 1220 is the average attrition rate for all of the products before an incident, while the attrition rate after 1222 is the average attrition rate for all of the products after an incident. In some embodiments, these rates are determined based on historical data from before and after incidents that occurred in the past within the business. Therefore in some embodiments may be assumptions or alternatively rates may be calculated based on the historical data.

The value 1214 for each FCI type may be determined by multiplying the new attrition rate 1222 by the average profitability of a customer that experienced the FCI (e.g., number of FCIs multiplied by the PI ratio and the profit per customer, which is the average profit of the business on a per customer basis), as illustrated by block 308 in FIG. 5. As illustrated by block 310 in FIG. 5, the cost of poor quality application 10 then subtracts from the number calculated in block 308 the previous attrition rate 1220 multiplied by the average profitability of a customer. This may be done for each FCI type listed in the FCI type section 1204 in FIG. 12. As illustrated by block 312 in FIG. 5, the cost of poor quality application 10 arrives at the potential attrition rate cost of each FCI in question and displays the attrition rates for severity 1, 2, and 3 FCIs in the attrition rate costs section 1224. In some embodiments, as illustrated in the FCI effects section 1230 the costs can also be broken down into no effects costs 1236, weekend only costs 1238, multiple channel only costs 1240, and combined costs 1242. The no effects cost 1236 is the sum of severity 1, 2, and 3 costs calculated in the attrition rate cost section 1224. The weekend only cost 1238 is determined by multiplying the no effect cost 1236 by a weekend factor, which increases the estimated attrition cost because the attrition rate is usually higher on weekends then during the week. The multiple channel costs 1240 are also determined by multiplying the no effect cost by a factor, which increases the attrition cost because the attrition rate cost is greater if the incident affects multiple channels as opposed to one channel. The increase in attrition due to an incident that affects multiple channels may be due in part to the customer being more aware of failures that affect multiple channels as opposed to just one channel. The combined costs 1242 is a combined weekend and multiple channel cost, which is calculated using a factor that takes into account both the weekend only cost 1238 and the multiple channel only cost 1240. The total attrition loss metric cost 1250 is determined based on the information entered into the general input section 1010. For example, if the incident affected multiple channels the total loss equals the affected multiple channels only cost 1240, if the incident occurred on the weekend the weekend only cost 1238 is used, and if the incident affected multiple channels and occurred on the weekend the combined cost 1242 equals the total attrition loss metric cost 1250. The total attrition cost percentage 1252 is the percentage of the total incident cost that can be associated to customer attrition.

In some embodiments of the invention, the total attrition cost 1250 can be further broken down into customer segments (either at the beginning or end of the process). For example, customer segments may be broken down to male and female, age groups (i.e. 18-30, 31-50, 51 and above, or the like), regions of the country (i.e. state, Northeast, etc.), or any other type of customer segment. In this way, the total attrition cost can be used to identify what customer segments had the most attrition costs related to the incident.

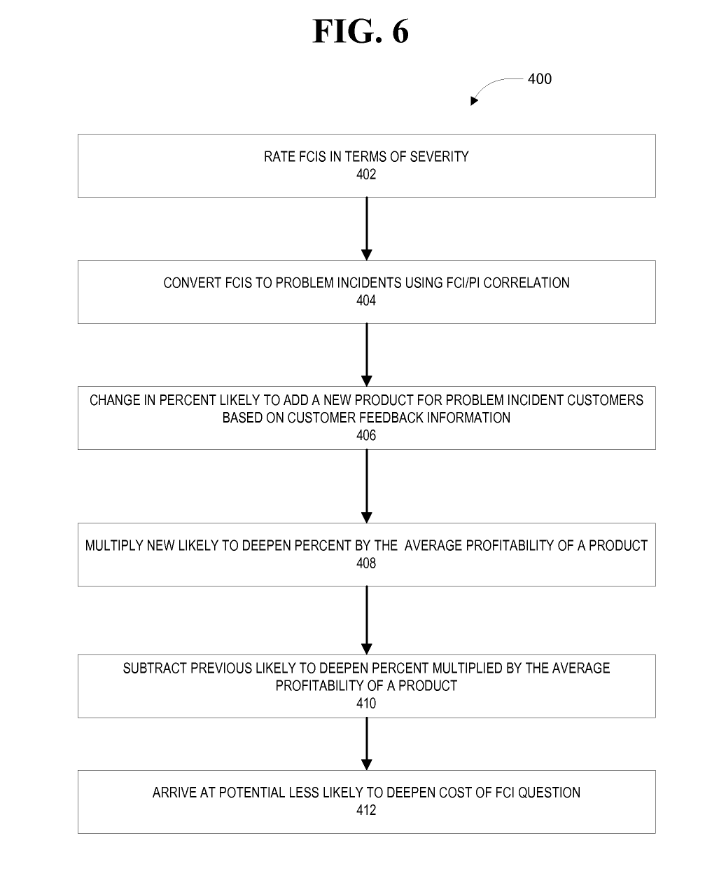

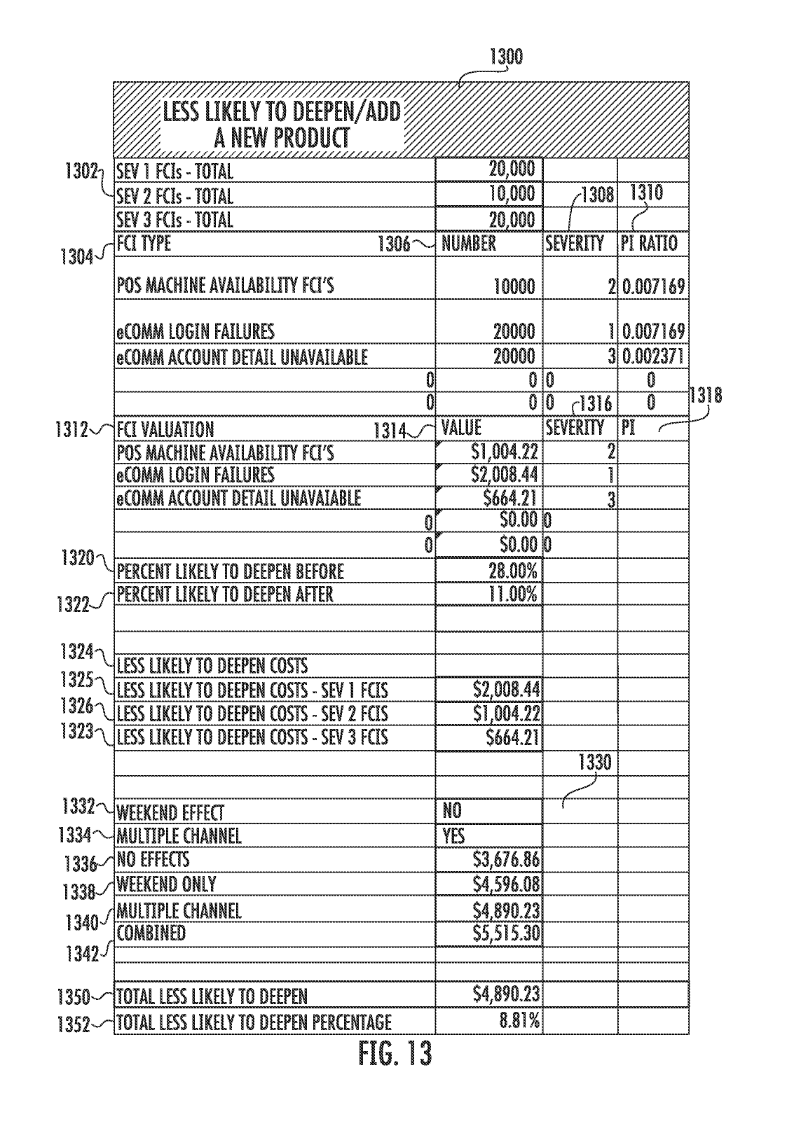

FIG. 6 illustrates a process flow for determining the less likely to deepen channel cost, which is illustrated in the less likely to deepen output interface illustrated in FIG. 13. As illustrated in block 402 in FIG. 6, in order to calculate the less likely to deepen channel cost 1350 the FCIs may be rated in terms of severity. This can be done in the same way as was previously described in block 302 of FIG. 5 for the process of calculating the attrition cost. As illustrated in block 404 in FIG. 6, the FCIs may then be converted to PIs using the FCI/PI correlation. This may also be done in the same way as was previously described in block 304 of FIG. 5 for the process of calculating the attrition cost. As was the case for the attrition rate output interface 1200, the less likely to deepen output interface 1300 illustrates a summary of the FCIs associated with each severity level in the FCIs severity section 1302. Furthermore, the FCI type section 1304, list the FCI number 1306, severity 1308, and PI ratio 1310, as they were entered or populated in the channel FCI costs section 1050.

The cost of poor quality application 10 calculates the FCI value 1314, the FCI severity 1316, and the PI ratio 1318 for each FCI in the FCI valuation section 1312. The percent likely to deepen before 1320 is the average deepen rate for all of the products before an incident, while the percent likely to deepen after 1322 is the average deepen rate after an incident. As illustrated by block 406, in one embodiment of the invention the rates are determined based on customer feedback information from surveys, customer inquires, social media, etc. In other embodiments, these rates are determined based on historical data from before and after incidents that occurred in the past. In still other embodiments these rates are based on assumptions.

The FCI value 1314 may be calculated by multiplying the percent likely to deepen after 1322 by the average profitability of a new product (e.g., number of FCIs multiplied by the PI ratio and the profit per new product, which is the average profit of a new product on weighted average basis), as illustrated by block 408 in FIG. 6. As illustrated by block 410 in FIG. 6, the cost of poor quality application 10 then subtracts from the number calculated in block 408 the percent likely to deepen before 1320 multiplied by the average profitability of a product. This is done for each FCI type listed in the FCI type section 1304. As illustrated by block 412 in FIG. 6, the poor cost of quality application 10 calculates at the potential less likely to deepen costs of each FCI in question and displays the less likely to deepen costs for severity 1, 2, and 3 FCIs in the less likely to deepen cost section 1324. In some embodiments, as illustrated in the FCI effects section 1330 the costs can also be broken down into no effects costs 1336, weekend only costs 1338, multiple channel only costs 1340, and combined costs 1342. The no effects cost 1336 is the sum of severity 1, 2, and 3 costs calculated above. The weekend only cost 1338 is determined by multiplying the no effect cost 1336 by a weekend factor, which increases the less likely to deepen cost because the cost is typically higher on weekends then during the week. The multiple channel costs 1340 are also determined by multiplying the no effect cost 1336 by a factor, which increases the less likely to deepen cost because the less likely to deepen cost is greater if the incident affects multiple channels as opposed to one channel. This may be due in part to customers being more aware of failures that affect multiple channels as opposed to just one channel. The combined costs 1342 is a combined weekend and multiple channel cost, which is calculated using a factor that takes into account both the weekend only cost 1338 and the multiple channel only cost 1340.

The total less likely to deepen cost 1350 is determined based on the information entered into the general input section 1010. For example, if the incident affected multiple channels the total less likely to deepen cost 1350 equals the affected multiple channel cost 1340, if the incident occurred on the weekend the weekend only cost 1338 is used, and if the incident affected multiple channels and occurred on the weekend the combined cost 1342 equals the total less likely to deepen cost 1350. The total less likely to deepen cost percentage 1352 is the percentage of the total incident cost that can be associated to the likelihood of a customer not purchasing additional products. As previously described with the attrition costs 1250, the total less likely to deepen cost 1350 can be broken down into customer segments.

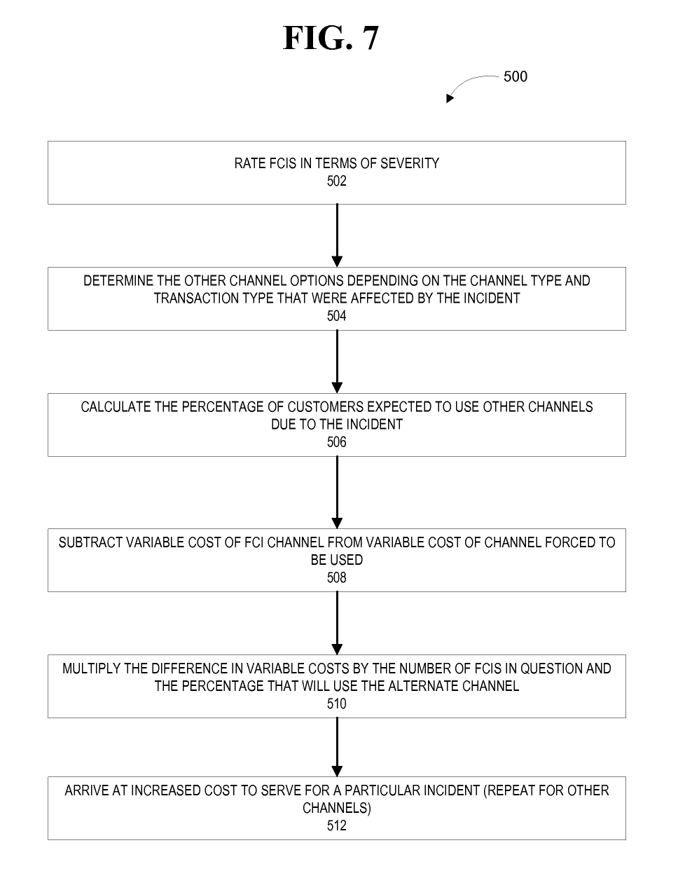

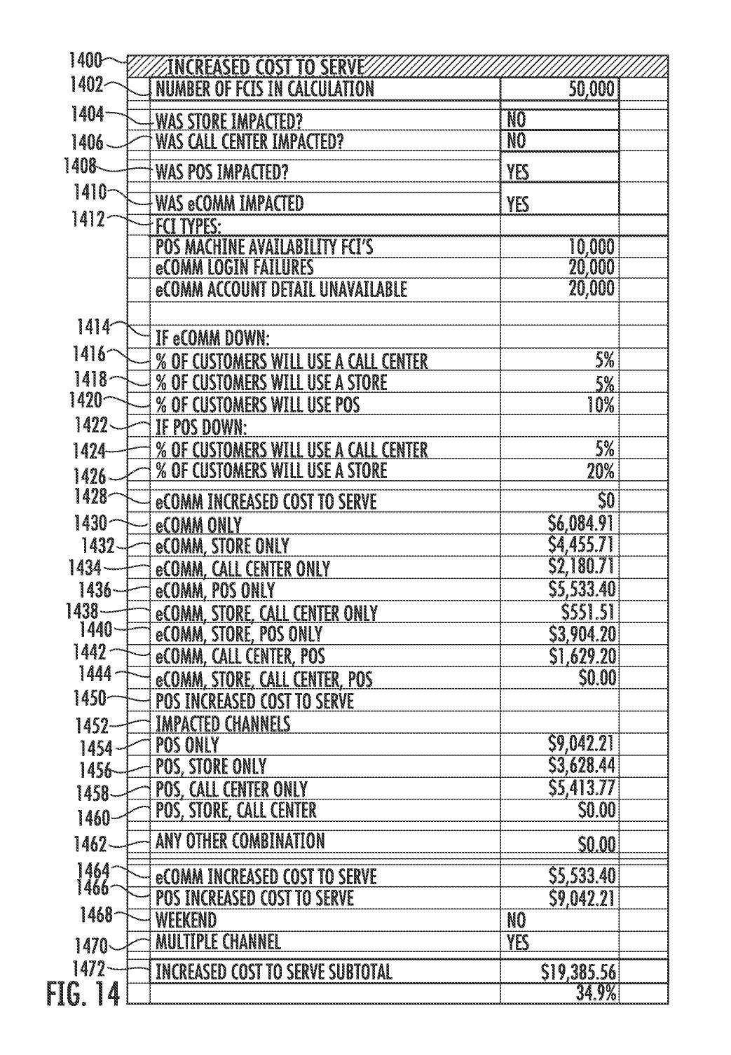

FIG. 7 illustrates a process flow for determining the increased cost to serve for the channel FCI cost, which is illustrated in the increased cost to serve output interface 1400 in FIG. 14. As illustrated in block 502 of FIG. 7, the FCIs may be rated in terms of severity. As was the case with the attrition cost process 300 and the less likely to deepen cost process 400, the FCI severity can be calculated in the same or similar way as it was calculated in blocks 302 and 402. In one embodiment of the invention, as illustrated in the number of FCIs section 1402, the number of FCIs for the incident is listed, as well as the channels impacted. Furthermore, as illustrated in the FCI types section 1412 the cost of poor quality application 10 breaks the total FCIs down by FCI types 1412.

As illustrated by block 504, the other channel options available to customers are determined depending on channel type and transaction type that were affected by the incident. In order to do this the cost of poor quality application 10 determines the other available channels if a single channel experiences an outage. For example, if the e-commerce channel experiences an outage, customers can utilize other channels such as, the call center, store, POS machine, etc. and visa versa for any other channel that experiences an outage. In some embodiments if one channel is experiencing an outage the customer cannot or may likely not use another channel, therefore, the other channel may not be included in the calculations.

As illustrated by block 506, the percentage of customers expected to use other channels due to the incident is calculated. For example, as illustrated in the e-commerce down section 1414, if the e-commerce channel is down then the cost of poor quality application 10 lists the percentage of customers that will become call center customers 1416, store customers 1418, and POS customers 1420. These values are the percentages of customers that would use the other channels in lieu of the e-commerce channel. Furthermore, the POS down section 1422 lists the percentage customers that will become call center customers 1424 and store customers 1426, if the POS machines experienced an outage. In some embodiments, the percentages are based on historical data from customer surveys, customer contact e-mails, social media, etc. In some embodiments of the invention, the user 3 can determine the customer percentages based on the incident, FCIs, and the user's knowledge of the channels that customers would typically utilize during outages of other channels.

As illustrated by block 508 the increased cost to serve for a channel is calculated by subtracting the variable cost of the channel related to the incident from the variable cost of the channel forced to be used because of the incident. Thereafter, as illustrated by block 510 the increased cost to serve for a channel is calculated by multiplying the difference in variable costs by the total number FCIs and the percentage of FCIs that will use the alternate channels. For example, as illustrated in the e-commerce increased cost to serve section 1428, the e-commerce only cost 1430 is found by taking the difference in the variable cost of the call center and the e-commerce channel multiplied by the total FCIs and the percentage of customers who will use the call center. This is added to the difference in the variable cost of the store and the e-commerce channel multiplied by the total FCIs and the percentage of customers who will use the store. This is added to the difference in the variable cost of the POS and the e-commerce channel multiplied by the total FCIs and the percentage of customers who will use the POS. The sum of the three values results in the e-commerce only increased cost to serve 1430. Similar calculations are done for the combination of channels as illustrated in the e-commerce increased cost to serve section 1420 and the POS increased cost to serve section 1450.

As illustrated by block 512 in FIG. 7, the result of the calculation is the increased cost to serve for a particular incident. As illustrated by the e-commerce total increased cost to serve 1464, the cost is equal to the cost for the e-commerce and POS only 1436. This is because the incident in the illustrated example involved an outage to the e-commerce channel and POS channel, therefore, the increased cost to serve equals the increased cost to severe when the incident affects the e-commerce and POS channels only 1436. Also, the POS total increased cost to serve 1466 is equal to the POS only cost 1554 because there is no POS and e-commerce only cost in the POS increased cost to serve section 1452. This may be due, for example, to the fact that in this particular example a customer who is using a POS that has an outage is not likely to use the alternate e-commerce channel to complete the transaction, otherwise the customer most likely would have used the e-commerce channel in the first place before finding a POS. Finally, the total increased cost to serve subtotal 1472 is the sum of the e-commerce cost to serve 1464 and the POS increased cost to serve 1466 multiplied by a factor if the incident occurred on the weekend 1468 and/or if multiple channels 1470 were involved. The factor is based on historical data or assumptions of increased cost when an incident affects multiple channels or occurs on the weekend.

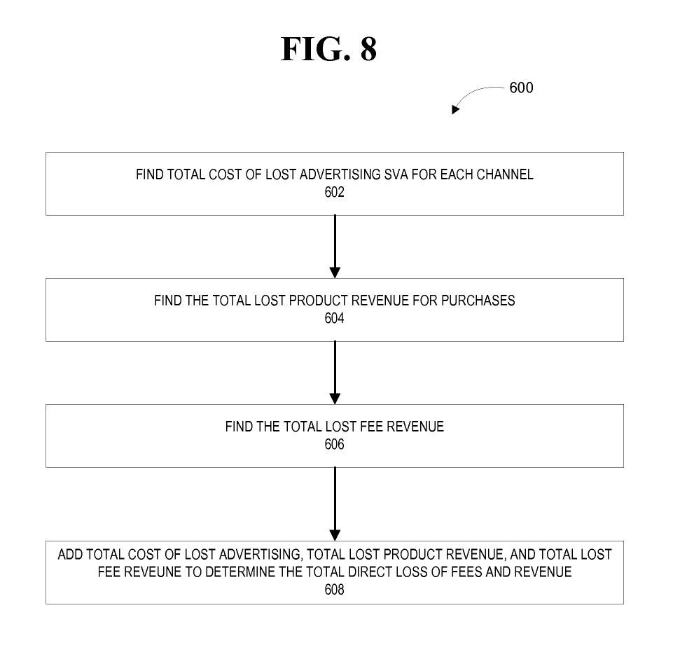

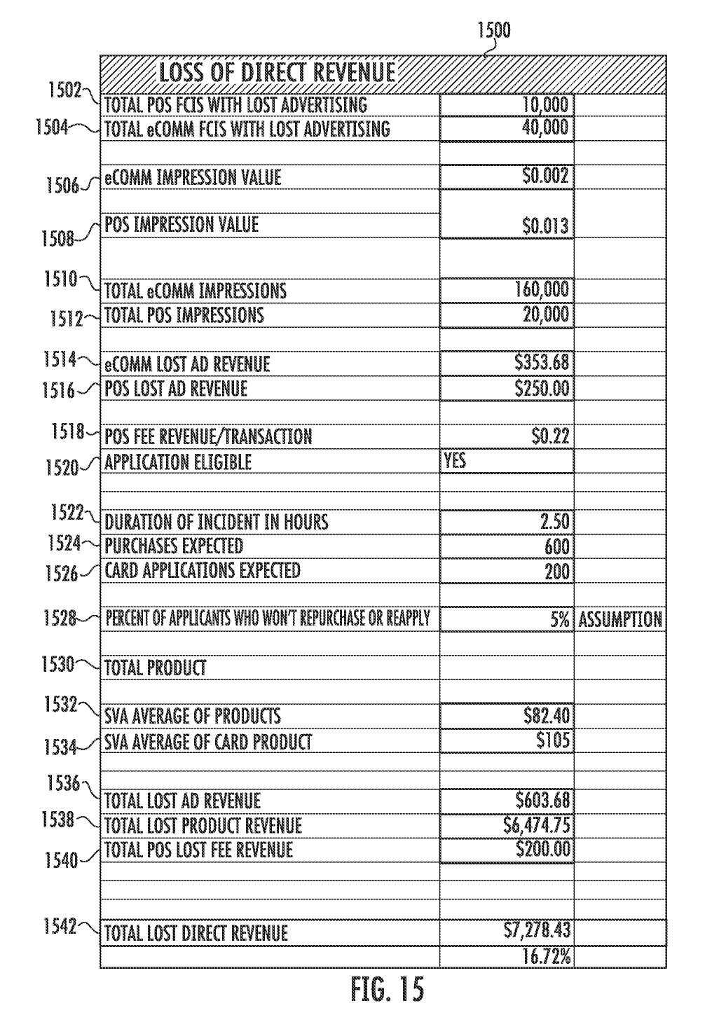

FIG. 8 provides a process flow for determining the direct loss of revenue cost for the channel FCI costs. As illustrated by block 602, the total cost of lost advertising may be found our calculated. As illustrated in FIG. 15, the loss of direct revenue output interface 1500 illustrates how to calculate the total lost direct revenue in our example. In order to do this the total advertising shareholder value added (“SVA”) for each channel is determined. Thereafter, the total SVA for each channel is divided by the total number of channel impressions which results in the impression cost. For example, if there is $60,000 in advertising revenue for a channel and there are 15,000,000 impressions for the channel, then the impression cost will be $0.004 per impression. In the example illustrated in FIG. 15, the total e-commerce impression value 1506 is $0.002 per impression. The next step is to determine the total number of impressions lost because of the incident. For example, in the case of the total e-commerce impressions lost 1510, if each customer on average visits two pages and receives two impressions per page, then since there are 40,000 total e-commerce FCIs 1504 this results in 160,000 total lost e-commerce impressions 1510. The e-commerce lost advertising revenue 1514 is calculated by multiplying the e-commerce impression value 1506 by the total e-commerce impressions 1510. The same calculations can be done for the other channels, such as the POS channel in the example illustrated in FIG. 15.

As illustrated by block 604, the cost of poor quality application 10 may also calculate the lost purchases expected 1524. In order to determine the lost purchases expected 1524 the average number of purchases per hour 1524 may be determined based on historical data. In some embodiments of the invention, the customer may also take out credit cards from the business which also results in a loss of revenue. Therefore, in some embodiments the card application loss expected 1526 is also determined. The percentage of customers who won't repurchase or reapply 1528 for the card is determined, and may be estimated based on historical data or assumptions made by the business. The SVA of the products 1532 is determined, which is the average profit made from each purchase for the business. The SVA of the average card products 1534 is also determined, which may be higher in some cases because of the added discount customers get when purchasing products with a card issued by the business. The total lost product revenue 1538 is determined by multiplying the duration of the incident 1522 by the purchases expected 1524 per unit time and by the SVA average products 1532, as well as in some embodiments by an acceptance rate or percentage of returns rate. In some embodiments this number is reduced by the percentage of customers that won't repurchase or reapply 1528. The lost revenue from card applications can be calculated in the same or similar way.

As illustrated by block 606 the lost fees may also be calculated in some embodiments of the invention. For example, the business may receive a fee every time a POS machine is used. This may be the case for a vending company, bank, or other business that uses POS machines. For example, a business may know that they receive on average $0.02 per transaction on a POS machine based on historical data or other assumptions. Therefore, the number of FCIs 1502 is multiplied by the fee per transaction 1518 to get the total POS lost fee revenue 1540.

As illustrated by block 608 the total lost ad revenue 1536, is added to the total lost product revenue 1538, and the total POS lost fee revenue 1540 to get the total lost direct revenue 1542.

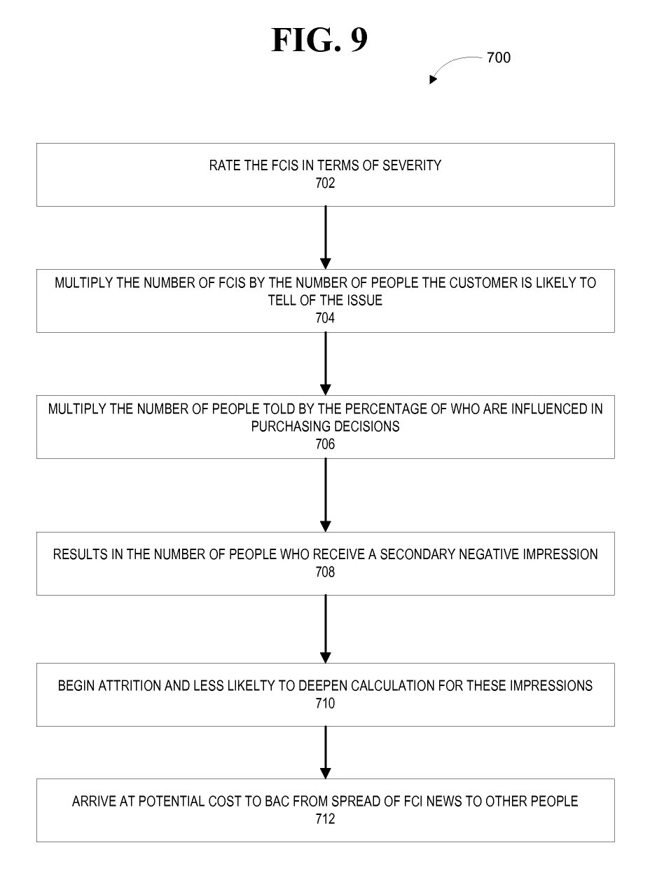

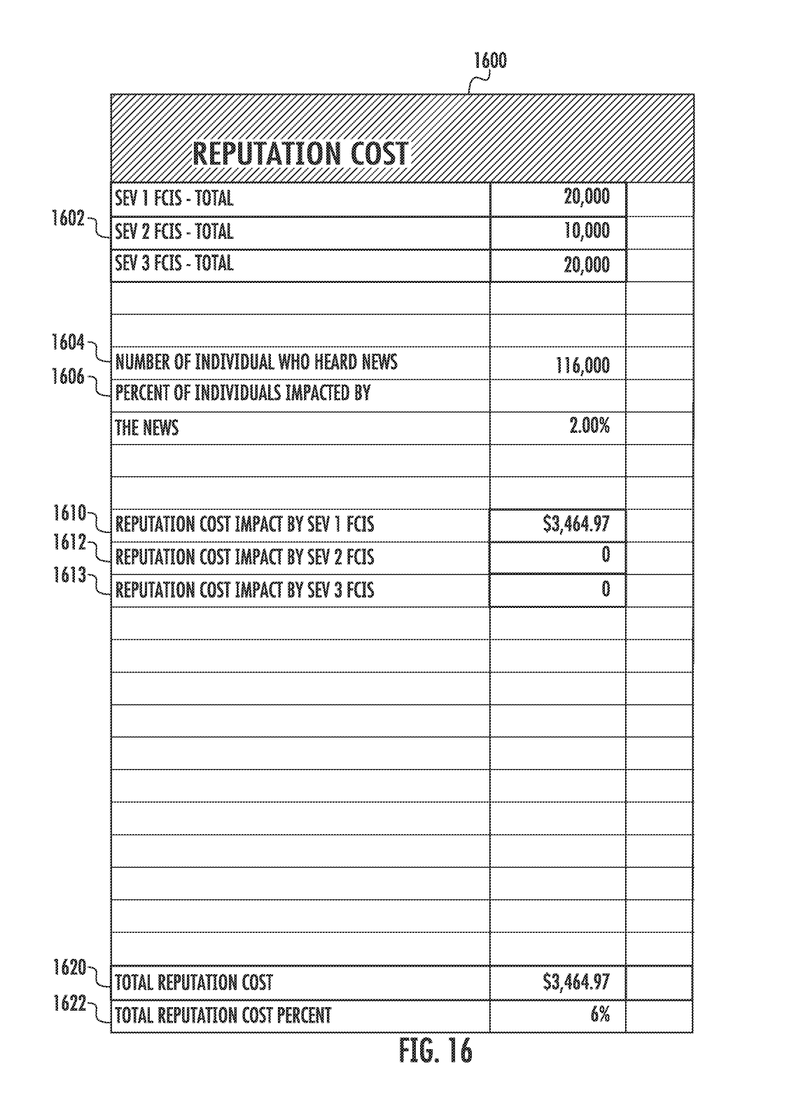

As illustrated by block 700 of FIG. 4, the channel FCI cost may also have a reputation cost component. FIG. 9 illustrates a process flow for determining the reputation cost 700, in accordance with one embodiment the invention. As illustrated in block 702 of FIG. 9, the FCIs may be rated in terms of severity. As was the case with the attrition cost process 300, the less likely to deepen cost process 400, and the increased cost to serve process 500 the FCI severity can be calculated in the same as it was calculated in block 302, 402, and 502. FIG. 16 illustrates the reputation cost output interface 1600. The reputation cost output interface 1600 illustrates the total FCIs for each severity level in the FCI severity section 1602.

As illustrated by block 704, the number of FCIs may be multiplied by the number of people a customer is likely to tell about the incident. For example, severity 1 FCIs are more severe than severity 2 FCIs, therefore customers will most likely tell more people about severity 1 FCIs than severity 2 FCIs. Severity 2 FCIs are more severe than severity 3 FCIs, therefore customers will most likely tell more people about the severity 2 FCIs than the severity 3 FCIs. Since the customers may not even recognize severity 3 FCIs, they may not tell any other people about the severity 3 FCIs. The reputation cost output interface displays the number of individuals who heard the news 1604, which represents the sum of the severity 1, 2, and 3 FCIs multiplied by the number of people a customer is likely to tell for each severity level.

As illustrated by block 706, the number of people who heard the news 1604 may be multiplied by the percentage of people impacted by the news 1606. Only a certain percentage of the people that are told about the incident will actually make a purchasing decision based on the negative impression. As illustrated in FIG. 16 the reputation cost output interface 1600 displays the percent of individuals impacted by the news 1606. As illustrated in block 708 of FIG. 9, the calculation in block 706 results in the number of people who receive a secondary negative impression of the incident.

In some embodiments of the invention, the percentage of people who are impacted by the news 1606 may be higher for severity 1 FCIs as opposed to severity 2 FCIs, as well as severity 2 FCIs as opposed to severity 3 FCIs, thus, different percentages may be used for different levels of FCIs in some embodiments of the invention. Therefore, in some embodiments of the invention, the number of individuals who receive a secondary negative impression is based on different percentages for severity 1, severity 2, and severity 3 FCIs.

As illustrated in block 710, attrition and less likely to deepen calculations are made for the number of people who receive a secondary negative impression. A percentage of the number of people who receive a secondary negative impression are already bank customers and a percentage of them are not bank customers, which can be assumed based on population numbers, geographic customer location numbers, etc. In some embodiments of the invention the cost is a function of the attrition of current customer, less likely to deepen of current customers, and less likely of non-customers to become customers. The cost due to the attrition of current customers is measured by the number of people who receive a secondary negative impression multiplied by the percentage of people that are customers, multiplied by the profitability of an average customer, multiplied by an attrition rate. The attrition rate can be determined by historical data or assumptions. The less likely to deepen cost of the current customers is measured by the number of people who receive a secondary negative impression multiplied by the percentage who are customers, multiplied by the average profit of additional products purchased, multiplied by a percentage of the likelihood of purchasing additional products. The percentage of likelihood of purchasing additional products can be determined by historical data or assumptions. The less likely to deepen cost of non-customers becoming customers is measured by the number of people who receive a secondary negative impression multiplied by the percentage who are not customers, multiplied by the average profitability of an average customer, multiplied by percentage of the likelihood that a non-customer would become a customer. The percentage of the likelihood of a non-customer becoming a customer can be determined by historical data or assumptions. These costs are summed, depending on the situation, and result in the reputation cost for the FCI channel cost. The reputation cost can be broken down into reputation cost impact by severity 1 FCIs 1610, severity 2 FCIs, severity 3 FCIs, as illustrated in the reputation output interface 1600. The cost for each level of severity is summed, and as illustrated by block 712, results in the total reputation cost 1620, which is displayed in the reputation cost output interface 1600. The total reputation cost by percent 1622, is also illustrated in the reputation cost output interface 1600, and indicates the percentage of the reputation cost as a function of the total FCI channel cost.

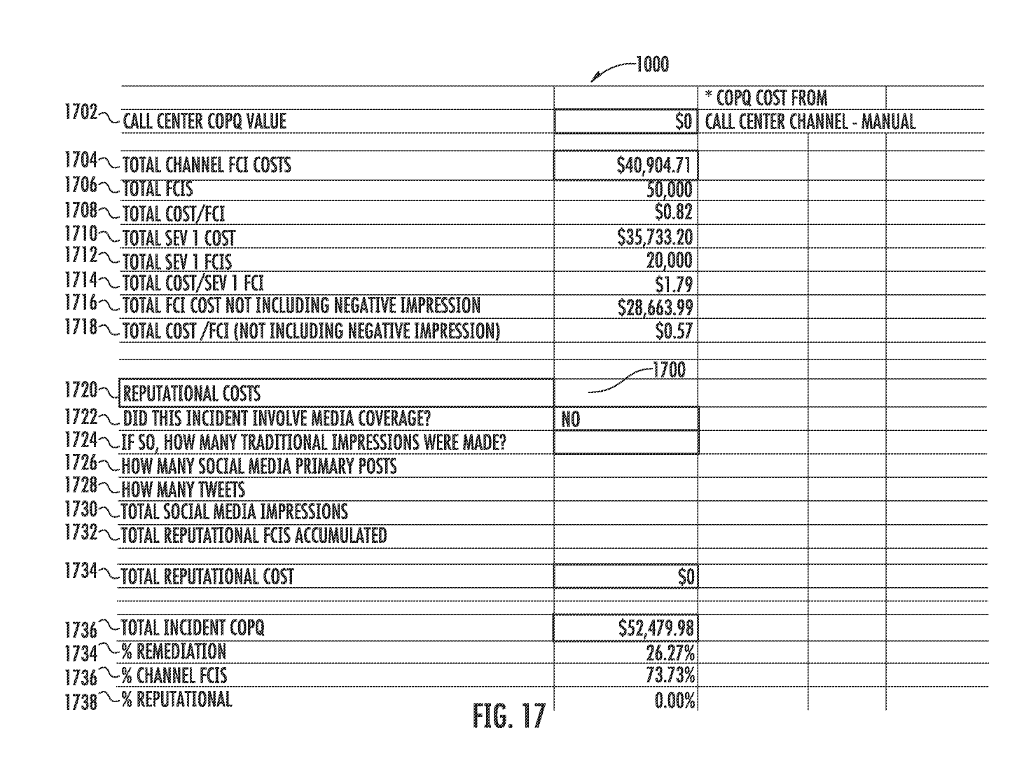

As illustrated by block 210 of FIG. 4, the total channel FCI costs 1704, as illustrated in the cost of poor quality interface 1000 in FIG. 17, is a result of the sum of the attrition cost 1250, the less likely to deepen cost 1350, the increased cost to serve 1475, the loss of direct revenue 1542, and the reputation cost 1620. In other embodiments of the invention the total channel FCI costs 1704 may be a function of one or more of these costs and/or other costs associated with the incident. In some embodiments of the invention other types of costs, not explained herein, may be added to the cost of poor quality application 10. Therefore, the total channel FCI costs 1704 can be easily modified with other associated costs at the business which might occur as a result of FCIs. The total channel FCI costs 1704 may also displayed and broken down further into other metrics, such as but not limited to, total FCIs 1706, total cost per FCI 1708, total severity 1 cost 1710, total severity 1 FCIs 1712, total cost per severity 1 FCIs 1714, total cost not including negative impression 1716, total cost per FCI not including negative impression 1718, etc., as illustrated in FIG. 17.

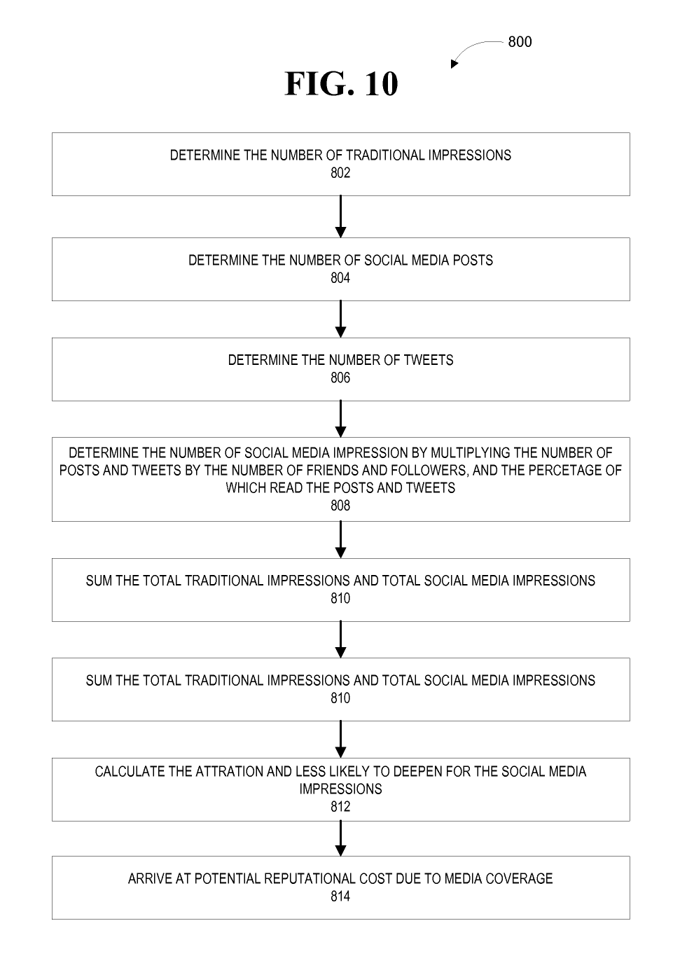

In some embodiments of the invention, a component of the total incident cost of poor quality can also be based in part on additional reputational costs as illustrated by block 800 in FIG. 1. FIG. 10 illustrates a process flow for determining the reputational costs 800, in accordance with one embodiment of the invention. FIG. 17 illustrates the reputational costs output interface 1700, including a reputational costs section 1720 comprising some questions to help quantify some of the reputational costs. In the example illustrated in FIG. 17 the incident did not involve media coverage. However, if media coverage of the incident did exist, as illustrated by block 802, the user 3 enters the number of traditional impressions 1724 made from the media coverage of the incident. A traditional impression 1724 is media coverage through a traditional channel, such as, but not limited to, newspaper paper articles, news channel stories, internet articles, etc. The traditional impressions made 1724 can be a function of the number of stories multiplied by the number of readers who accessed those stories. In some embodiments of the invention the number of traditional impressions can be populated automatically through the cost of poor quality application 10 receiving data directly or indirectly from news sites, other business applications 30, third-party media companies, etc.

As illustrated by block 804 in FIG. 10, the user 3 may enter into the reputational costs output interface 1700 the number of social media posts 1726 that were related to the incident. Thereafter, as illustrated by block 806, the user may enter into the reputational costs output interface 1700 the number of microblog updates 1728. The number of social media posts 1726 and/or microblog updates 1728 can be calculated by data mining from social media sites, using historical data, and/or making assumptions. As illustrated by block 808, the cost of poor quality application 10 may determine the total number of social media impressions 1730. In one embodiment of the invention the total social media impressions 1730 equals the total number of primary posts multiplied by the average number of friends each customer has, and multiplied by the percentage of friends who see the post, which can be based on an assumption. This number is added to the number of microblogs 1728 multiplied by the average number of microblog followers, and multiplied by the percentage of followers who read the microblogs. As illustrated by block 810, the total reputational FCIs accumulated is a sum of the total traditional media impressions 1724 and the total social media impressions 1730. As illustrated by block 812, the total reputational costs 1734 are calculated. In one embodiment, the total reputational costs 1734 are calculated by determining the attrition and less likely to deepen costs for current customers and/or non-customers who have been exposed to a media impression. These calculations are done in the same or similar way as calculated for block 710 in the reputation costs calculated for customers who tell other people about the incident through word of mouth. In some embodiments of the invention the reputational costs 1734 can be a part of the total the reputation cost 1620 calculated as a part of the total channel FCI costs 1704, or visa versa.

As illustrated by block 900 in FIG. 1 and in FIG. 17, the total incident cost of poor quality 1736 is calculated by adding the total remediation costs 1040, the total channel FCI costs 1704, and the total reputational costs 1734. The percentage cost of remediation 1738, percentage cost of channel FCIs 1740, and reputational percentage cost 1742 can also be displayed in the cost of poor quality interface 1000, as illustrated in FIG. 17.

The cost of poor quality application 10 can be used as tool to calculate end-to-end cost information related to how particular incidents affect various channels and lines of business within a business. All of the different costs associated with an incident can be brought into a single application allowing the business to determine to determine the most important incidents to investigate and fix. The user 2 of the cost of poor quality application 10 can add, remove, or change assumptions within the cost of poor quality application 10 on an incident by incident basis in order to provide more accurate evaluations of the actual costs within a business related to an incident. The ability to provide a general framework that can be customized for particular incidents helps a business to place values on identifying and fixing the systems, processes, and software within a business that lead to the various incidents.

In some embodiments the cost of poor quality application 10 can be utilized to identify the costs associated with specific FCIs, as opposed to an incident or group of incidents. For example, the incident may be only based on a single FCI, and thus the cost of poor quality calculated is based solely on a single FCI. Furthermore, the cost of poor quality application 10 may be customized to specific independent business groups or the whole business since the costs are calculated based on individual FCIs that can be measured as to how each individual FCI impacts the independent business groups differently.

In some embodiments the cost of poor quality application 10 can be linked to different types of customer information that is captured throughout the business, such as the information on the incident system 6 or other business systems 8. In this way, the cost of poor quality application 10 provides the ability to leverage the real-time, hourly, daily, etc. customer data captured by the business to provide up to date tracking and cost analysis of the FCIs within the business.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

U.S. patent application Ser. No. ______ to Heiman et al. and entitled “Incident Cost Model” is filed concurrently with the present application and is hereby incorporated by reference.

What is claimed is:

1. A method comprising:
determining a negative impression cost of an incident;
determining a direct loss of revenue cost of an incident;
determining an increased cost to serve of the incident; and
determining a channel failed customer interaction cost based in part on the negative impression cost, the direct loss of revenue cost, and the increased cost to serve, through the use of the processing device.

2. The method of claim 1, wherein the determining the negative impression cost comprises determining an attrition cost.

3. The method of claim 2, wherein determining the attrition cost comprises:
correlating failed customer interactions with a failed customer interaction value based on the severity of the failed customer interactions or the problem incident ratio;
determining the change in an attrition rate before and after the incident;
determining a profitability of a customer; and
calculating the attrition cost based at least in part on the failed customer interaction value, the change in the attrition rate, and the profitability of the customer.

4. The method of claim 1, wherein the determining the negative impression cost comprises determining a less likely to deepen cost.

5. The method of claim 4, wherein the determining the less likely to deepen cost comprises:
correlating failed customer interactions with a failed customer interaction value based on the severity of the failed customer interactions or the problem incident ratio;
determining the change in a likely to add a new product rate before and after the incident;
determining a profitability of a product; and
calculating the less likely to deepen cost at least in part on the failed customer interaction value, the change in the less likely to deepen rate, and the profitability of the product.

6. The method of claim 1, wherein the determining the negative impression cost comprises determining a reputation cost.

7. The method of claim 6, wherein the determining the reputation cost comprises:
determining a number of people that receive a secondary negative impression from the incident;
determining a secondary attrition cost for the number of people that receive the secondary negative impression;
determining a secondary least likely to deepen cost for the number of people that receive the secondary negative impression; and
calculating the reputation cost based at least in part on the secondary attrition cost or the secondary least likely to deepen cost.

8. The method of claim 1, wherein the determining the direct loss of revenue cost comprises:
determining a lost advertising cost;
determining a lost product revenue cost;
determining a lost fee revenue cost; and
calculating the direct loss of revenue cost based at least in part on the lost advertising cost, the lost product revenue cost, or the lost fee revenue.

9. The method of claim 1, wherein the determining the increased cost to serve comprises:
determining an available channel that can be used outside of an incident channel that is affected by the incident;
determining a number of failed customer interactions related to the incident;
determining a percentage of customers expected to use the available channel;
determining a difference in the cost to serve of the available channel and the incident channel; and
calculating the increased cost to serve based at least in part on the number of failed customer interactions, the percentage of customers expected to use the available channel, and the difference in the cost to serve of the available channel and the incident channel.

10. A system comprising:
a memory device having computer readable program code store thereon; and
a processing device operatively coupled to the memory device, wherein the processing device is configured to execute the computer readable program code for:
determining a negative impression cost of an incident;
determining a direct loss of revenue cost of an incident;
determining an increased cost to serve of the incident; and
determining a channel failed customer interaction cost based in part on the negative impression cost, the direct loss of revenue cost, and the increased cost to serve.

11. The system of claim 10, wherein the processing device configured to execute the computer readable program code for determining the negative impression cost comprises determining an attrition cost.

12. The system of claim 11, wherein the processing device configured to execute the computer readable program code for determining the attrition cost comprises:
correlating failed customer interactions with a failed customer interaction value based on the severity of the failed customer interactions or the problem incident ratio;
determining the change in an attrition rate before and after the incident;
determining a profitability of a customer; and
calculating the attrition based at least in part on the failed customer interaction value, the change in the attrition rate, and the profitability of the customer.

13. The system of claim 10, wherein the processing device configured to execute the computer readable program code for determining the negative impression cost comprises determining a less likely to deepen cost.

14. The system of claim 13, wherein the processing device configured to execute the computer readable program code for determining the less likely to deepen cost comprises:
correlating failed customer interactions with a failed customer interaction value based on the severity of the failed customer interactions or the problem incident ratio;
determining the change in a likely to add a new product rate before and after the incident;
determining a profitability of a product; and
calculating the less likely to deepen cost at least in part on the failed customer interaction value, the change in the less likely to deepen rate, and the profitability of the product.

15. The system of claim 10, wherein the processing device configured to execute the computer readable program code for determining the negative impression cost comprises determining a reputation cost.

16. The system of claim 15, wherein the processing device configured to execute the computer readable program code for determining the reputation cost comprises:
determining a number of people that receive a secondary negative impression from the incident;
determining a secondary attrition cost for the number of people that receive the secondary negative impression;
determining a secondary least likely to deepen cost for the number of people that receive the secondary negative impression; and
calculating the reputation cost based at least in part on the secondary attrition cost or the secondary least likely to deepen cost.

17. The system of claim 10, wherein the processing device configured to execute the computer readable program code for determining the direct loss of revenue cost comprises:
determining a lost advertising cost;
determining a lost product revenue cost;
determining a lost fee revenue cost; and
calculating the direct loss of revenue cost based at least in part on the lost advertising cost, the lost product revenue cost, or the lost fee revenue.

18. The system of claim 10, wherein the processing device configured to execute the computer readable program code for determining the increased cost to serve comprises:
determining an available channel that can be used outside of an incident channel that is affected by the incident;
determining a number of failed customer interactions related to the incident;
determining a percentage of customers expected to use the available channel;
determining a difference in the cost to serve of the available channel and the incident channel; and
calculating the increased cost to serve based at least in part on the number of failed customer interactions, the percentage of customers expected to use the available channel, and the difference in the cost to serve of the available channel and the incident channel.

19. A computer program product, the computer program product comprising at least one non-transitory computer-readable medium having computer-readable program code portions embodied therein, the computer-readable program code portions comprising:
an executable portion configured for determining a negative impression cost of an incident, through the use of a processing device;
an executable portion configured for determining a direct loss of revenue cost of an incident, through the use of the processing device;
an executable portion configured for determining an increased cost to serve of the incident, through the use of the processing device; and
an executable portion configured for determining a channel failed customer interaction cost based in part on the negative impression cost, the direct loss of revenue cost, and the increased cost to serve, through the use of the processing device.

20. The computer program product of claim 19, wherein the executable portion configured for determining the negative impression cost comprises an executable portion configured for determining an attrition cost.

21. The computer program product of claim 20, wherein the executable portion configured for determining the attrition cost comprises:
an executable portion configured for correlating failed customer interactions with a failed customer interaction value based on the severity of the failed customer interactions or the problem incident ratio;
an executable portion configured for determining the change in an attrition rate before and after the incident;
an executable portion configured for determining a profitability of a customer; and
an executable portion configured for calculating the attrition based at least in part on the failed customer interaction value, the change in the attrition rate, and the profitability of the customer.

22. The computer program product of claim 19, wherein the executable portion configured for determining the negative impression cost comprises an executable portion configured for determining a less likely to deepen cost.

23. The computer program product of claim 22, wherein the executable portion configured for determining the less likely to deepen cost comprises:
an executable portion configured for correlating failed customer interactions with a failed customer interaction value based on the severity of the failed customer interactions or the problem incident ratio;
an executable portion configured for determining the change in a likely to add a new product rate before and after the incident;
an executable portion configured for determining a profitability of a product; and
an executable portion configured for calculating the less likely to deepen cost at least in part on the failed customer interaction value, the change in the less likely to deepen rate, and the profitability of the product.

24. The computer program product of claim 19, wherein the executable portion configured for determining the negative impression cost comprises an executable portion configured for determining a reputation cost.

25. The computer program product of claim 24, wherein the executable portion configured for determining the reputation cost comprises:
an executable portion configured for determining a number of people that receive a secondary negative impression from the incident;
an executable portion configured for determining a secondary attrition cost for the number of people that receive the secondary negative impression;
an executable portion configured for determining a secondary least likely to deepen cost for the number of people that receive the secondary negative impression; and
an executable portion configured for calculating the reputation cost based at least in part on the secondary attrition cost or the secondary least likely to deepen cost.

26. The computer program product of claim 19, wherein the executable portion configured for determining the direct loss of revenue cost comprises:
an executable portion configured for determining a lost advertising cost;
an executable portion configured for determining a lost product revenue cost;
an executable portion configured for determining a lost fee revenue cost; and
an executable portion configured for calculating the direct loss of revenue cost based at least in part on the lost advertising cost, the lost product revenue cost, or the lost fee revenue.

27. The computer program product of claim 19, wherein the executable portion configured for determining the increased cost to serve comprises:
an executable portion configured for determining an available channel that can be used outside of an incident channel that is affected by the incident;
an executable portion configured for determining a number of failed customer interactions related to the incident;
an executable portion configured for determining a percentage of customers expected to use the available channel;
an executable portion configured for determining a difference in the cost to serve of the available channel and the incident channel; and
an executable portion configured for calculating the increased cost to serve based at least in part on the number of failed customer interactions, the percentage of customers expected to use the available channel, and the difference in the cost to serve of the available channel and the incident channel.
